(19) United States
(12) Patent Application Publication
(10) Pub. No.: US 2011/0211811 A1
(43) Pub. Date: Sep. 1, 2011

(54) SELECTING A VIDEO IMAGE

(76) Inventors: April Slayden Mitchell, San Jose, CA (US); Mitchell Trott, San Mateo, CA (US); W. Alex Vorbau, Los Altos, CA (US)

(21) Appl. No.: 13/125,761

(22) PCT Filed: Oct. 30, 2008
(86) PCT No.: PCT/US08/81883

§ 371 Date: Apr. 22, 2011

(51) Int. Cl. H04N 9/80

(52) U.S. Cl. 386/241; 386/E09.011

(57) ABSTRACT

Enabling a selection of a video image is described. A selection of a representative image is received [405], wherein the representative image is associated with a first set of selectable representative images corresponding to a first section of a video. In response to the selection, displaying [410] the first set of selectable representative images, wherein each of the first set is associated with a second set of selectable representative images corresponding to a sub-section of the first section. The receiving and the displaying continues [415] until a target representative image is displayed, thereby enabling refinable selecting of the target representative image.

### FIELD

The field of the present technology relates to computing systems. More particularly, embodiments of the present technology relate to video images,

### BACKGROUND

Participating in the world of sharing on-line videos can he a rich and rewarding experience. For example, one may easily share on-line videos with friends, family, and even strangers. Additionally, there are many different ways of representing on-line video content.

For example, in many video sharing systems, when a user uploads a video, either an image is selected for them by the system or the user is given three options (usually images from the beginning, middle, and the end of the video) from which to choose. This gives the user some choices. However, if the video is long, or the user does not desire the images, then the user has limited alternatives. Some sites allow the user to choose from every image in the video, but this leads to an overwhelming number of options and a complicated interface for the user.

### BRIEF DESCRIPTION OF THE DRAWINGS

The accompanying drawings, which are incorporated in and form a part of this specification, illustrate embodiments of the technology for enabling a selection of a video image, together with the description, serve to explain principles discussed below:

FIG. 1 is a block diagram of an example system of enabling a selection of a video image, in accordance with embodiments of the present technology,

FIG. 2 is an illustration of an example method of enabling a selection of a video image, in accordance with embodiments of the present technology.

FIG. 3 is an example tracking chain, in accordance with embodiments of the present technology.

FIG. 4 is a flowchart of an example method of enabling a selection of a video image, in accordance with embodiments of the present technology.

FIG. 5 is a diagram of an example computer system used for enabling a selection of a video image, in accordance with embodiments of the present technology.

FIG. 6 is a flowchart of an example method of enabling a selection of a video image, in accordance with embodiments of the present technology.

The drawings referred to in this description should not be understood as being drawn to scale unless specifically noted.

### DESCRIPTION OF EMBODIMENTS

Reference will now be made in detail to embodiments of the present technology, examples of which are illustrated in the accompanying drawings. While the technology will be described in conjunction with various embodiments), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, embodiments of the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “receiving”, “displaying”, “continuing”, “signaling”, “highlighting”, “accessing”, “comparing”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, optical and mechanical computers.

### Overview of Discussion

Embodiments in accordance with the present technology pertain to a system for enabling a selection of a video image and its usage. In one embodiment in accordance with the present technology, the system described herein enables refinable selecting of a target representative image.

More particularly, in one embodiment, a user is given selection choices of images representing content within a video. These representative images represent sections of the video corresponding to a specific time frame. For example, a sixty second video of a child's birthday party contains thousands of representative images. A user may wish to find the image of the child making a wish. Instead of overwhelming the user by presenting thousands of available representative images for selection, embodiments of the system described herein present the user with a few representative images of that video for selection.

For example, for a sixty second video, three representative images may be presented to the user for selection. Each of these three representative images corresponds to twenty seconds of consecutive non-overlapping video frames. For example, the first representative image may be that of a birthday cake being brought to the child. The second representative image may be that of the child blowing out the candles. The third representative image may be that of the child trying to cut the cake.

In trying to locate a target representative image, that of the child making a wish, the user selects the representative image of a birthday cake being brought to the child. This representative image corresponds to the first twenty seconds of the video. In response to this selection, a refined set of representative images is presented. For example, the refined set of representative images includes two additional representative images. One of the representative images may be the lighting of birthday candles. The other representative image may be that of the child making a wish, the target representative image.

Thus, the user is able to locate the target representative image in only a few selections. Embodiments of the present technology enable the refinement of a selected representative image without overwhelming the user with the thousands of representative images available for viewing.

### System for Enabling a Selection of a Video Image

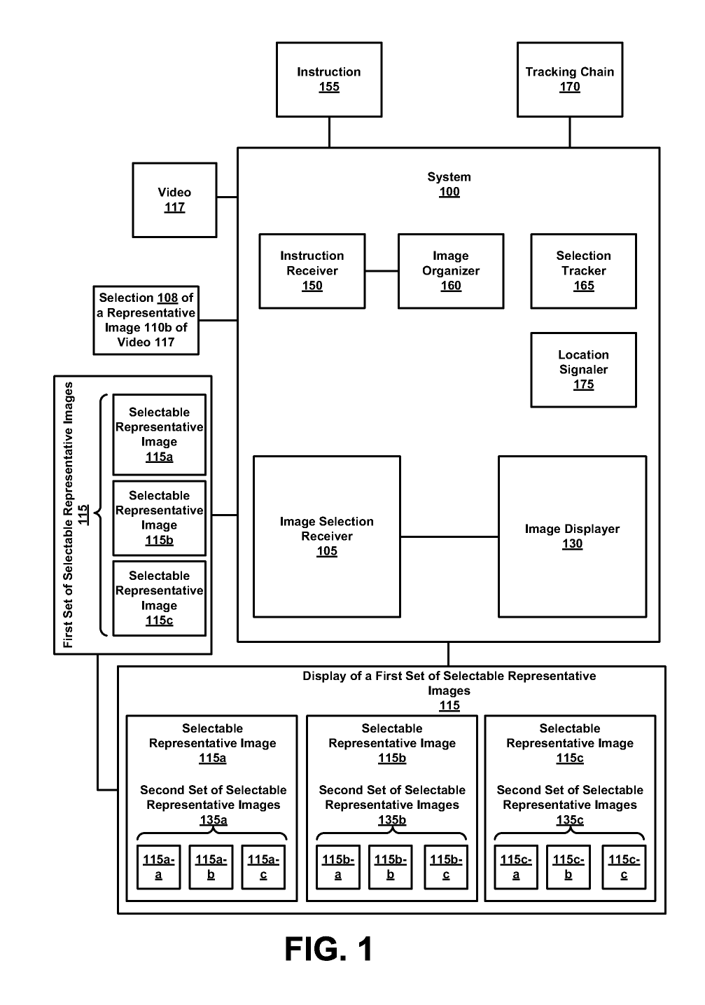

FIG. 1 is a block diagram of an example system 100 in accordance with embodiments of the present technology. System 100 includes image selection receiver 105, image displayer 130, instruction receiver 150, image organizer 160, selection tracker 165, and location signaler 175.

Referring still to FIG. 1, in one embodiment, image selection receiver 105 receives selection 108 of representative image 110b from a human or computer. Selection 108 is an indicator that a representative image of a video has been chosen, according to embodiments of the present technology. For example, representative image 110b may have been chosen based on variables such as, but not limited to, image quality, time offset into video 117, and image content.

In embodiments of the present technology, representative image 110b is a still image that itself represents a specific frame of time within video 117, This frame of time may be, but is not limited to, a predetermined instruction 155 from a source outside of the system 100, and/or may be a default setting defined by the system designer. For example, a user may give instruction 155 to system 100 that each representative image is to represent one third of video 117, thereby creating three sections. Instruction 155 may further require that each subsequent division of each representative image is to represent one-third of the original representative image, thereby creating three sub-sections for each of the original three sections.

In another embodiment, a default setting defined by the designer of system 100 states that each representative image is to represent one half of video 117, thereby creating two sections. The instruction 155 may further require that each subsequent division of each representative image is to represent one-half of the original representative image, thereby creating two sub-sections for each of the original two sections.

In one embodiment, selection 108 of representative image 110b of video 117 is shown in FIG. 1. Representative image 110b of video 117 is associated with first set of selectable representative images 115, the set containing selectable representative images 115a, 115b, and 115c. Image 115a is associated with a second set of selectable representative images 135a. Image 115b is associated with a second set of selectable images 135b. Furthermore, image 115c is associated with a second set of selectable representative images 135c.

The sets 135a, 135b, and 135c contain the following selectable representative images, respectively: 115a-a, 115a-b, 115a-c; 115b-a, 115b-b, 115b-c; and 115c-a, 115c-b, and 115c-e. Of note, embodiments of the present technology are well suited for any number of selectable representative images and subsets thereof of selectable representative images.

In one embodiment, video 117 and tracking chain 170 are coupled with system 100. In one embodiment, video 117 refers to any video capable of having a representative image selected therefrom. Tracking chain 170 coupled with system 100 is for tracking the receiving of a selection of a representative image and the displaying of a set of representative images associated with a selectable representative image. Tracking chain 170 may be internal to and/or external to system 100.

### Operation

More generally, in embodiments in accordance with the present technology, system 100 is utilized to enable a selection of a video image. Such a method of selection is particularly useful to a user to quickly and efficiently refine a selection in order to locate a target representative image within a video.

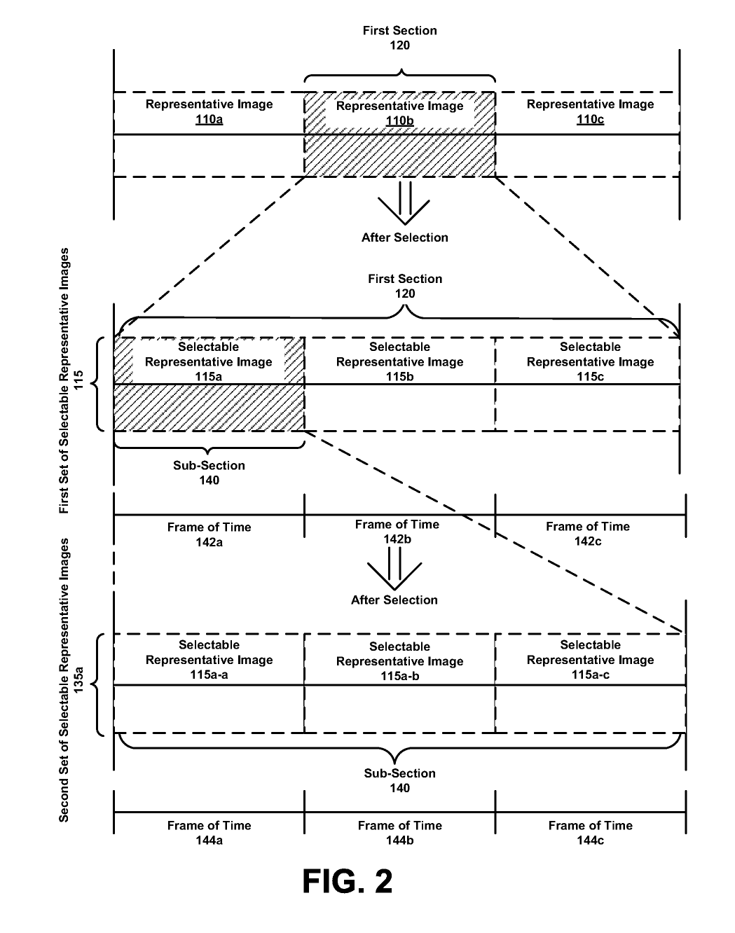

Referring now to FIG. 2, an illustration of an example method for enabling a selection of a video image in accordance with embodiments of the present technology is shown. In one embodiment, image selection receiver 105 receives a selection 108 of a representative image 110b of video 117. Representative image 110b is associated with first set of selectable representative images 115 corresponding to first section 120 of video 117.

In one embodiment, image displayer 130 displays first set of selectable representative images 115 in response to the receiving of selection 108 of representative image 110b of video 117. Image 115a in set 115 is associated with a second set of representative images 135a corresponding to sub-section 140 of first section 120.

In one embodiment, representative image 110b is displayed alongside two other representative images, representative image 110a and representative image 110c.

In one embodiment, image 115a is associated with frame of time 142a, image 115b is associated with frame of time 142b, and image 115c is associated with frame of time 142c. Each frame of time 142a, 142b, 142c does not overlap with each other or any other frame of time within any section of video 117. In other words, each sub-section of first section 120 corresponds to different and completely separate frames of time.

However, embodiments of the present technology are well suited to having overlapping sub-sections corresponding to representative image 110b. For example, frames of time 142a, 142b, and 142c may correspond to sub-sections of first section 120 that overlap.

In another embodiment, each selectable representative image 115a-a, 115a-b, and 115a-c of set 135a represents frame of time 144a, 144b, and 144c, respectively. Each frame of time 144a, 144b, and 144c does not overlap with each other or any other frame of time within sub-section 140 of first section 120. In other words, each section of sub-section 140 corresponds to different and completely separate frames of time.

However, embodiments of the present technology are well suited to having overlapping sections of sub-section 140 corresponding to images 115a-a, 115a-b, and 115a-c. For example, frames of time 144a, 144b, and 144c may correspond to sections of sub-section 140 that overlap.

In one embodiment, instruction receiver 150 receives instruction 155, wherein instruction 155 designates a range of time that images 110a, 110b, and 110c are to represent. Then, image organizer 160 configures images 110a, 110b, and 110c according to instruction 155, For example, instruction receiver 150 receives instruction 155 stating that each of images 110a, 110b, and 110c is to represent equivalent ranges of time. Video 117 is sixty seconds long. Thus, image organizer 160 configures each of images 110a, 110b, and 110c to represent twenty seconds of video 117.

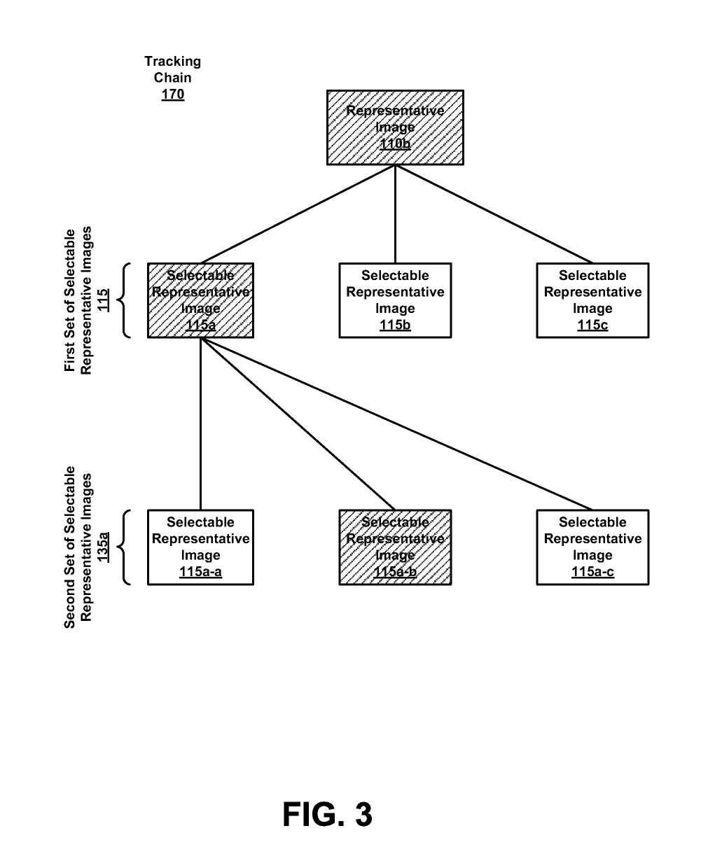

Referring now to FIG. 3, an example tracking chain 170 in accordance with embodiments of the present technology is shown. In one embodiment, selection tracker 165 displays tracking chain 170 of selected representative images, wherein tracking chain 170 tracks the receiving and displaying described herein. For example, tracking chain 170 shows through diagonal markings that image 110b, image 115a, and image 115a-b were selected. Of note, embodiments of the present technology are well suited to any number of methods of signifying a selection of a selectable representative image, such as, but not limited to, using different colors to highlight selections, marking selections with diagonal lines, circular marks, dots, etc.

In one embodiment, location signaler 175 signals a location of image 110b within video 117. For example, and referring to FIG. 2, image 110b was selected. Image 110b is shown with diagonal markings across it, signaling the location of the selection 108 within video 117 as being in the middle third of video 117. Of note, embodiments of the present technology are well suited to signaling the location of image 110b in a manner other than showing diagonal line markings. For example, tire location of selection 108 of image 110b may be highlighted. The highlighting may be in any predetermined color. Also, embodiments of the present technology are well suited to signaling the location of image 115a, selectable representative image 115a-b, and any other selected representative image, within video 117. In one embodiment, these locations may be expressed via highlighting a portion of a time line representing the length of video 117 corresponding to the particular location of the selected representative image within video 117.

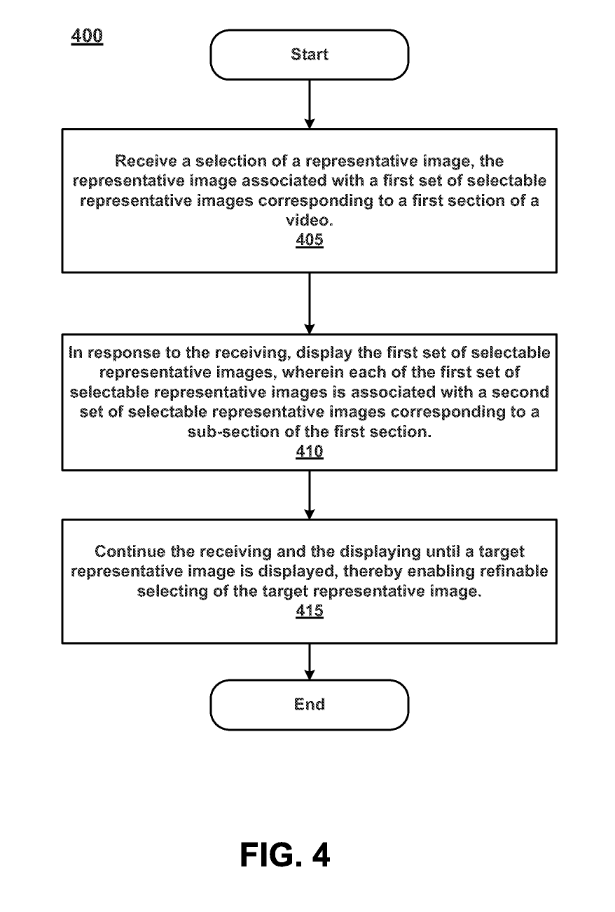

FIG. 4 is a flowchart of an example method of enabling a selection of a video image, in accordance with embodiments of the present technology. With reference now to 405, selection of image 110b is received. Image 110b is associated with set 115 corresponding to first section 120 of video 117.

Referring to 410 of FIG. 4, in one embodiment of the present technology, in response to receiving 405, set 115 is displayed. As described in paragraphs 24 and 25 herein, set 115 is associated with second sets of selectable representative images 135a, 135b, and 135c. Set 135a contains images 115a-a, 115a-b, and 115a-c, corresponding to sub-section 140 of first section 120.

Referring to 415 of FIG. 4, in one embodiment, receiving 405 and displaying 410 continue until a target representative image is displayed, thereby enabling refinable selecting of a target representative image. For example, it may be that the target representative image of a user is that of image 115a-b, When image 115a-b is displayed, a user may decide not to refine the target representative image 115a-b. Therefore, receiving 405 of a selection and displaying 410 of a selection described herein has ended.

In another embodiment, and referring to FIG. 3, a selection of a first portion of a displayed tracking chain 170 is received. In one embodiment, this first portion is image 115a-b. However, embodiments of the present technology are well suited to a selection of any part of tracking chain 170 as the first portion. In one embodiment, in response to receiving a selection of first portion 1I5a-b, image 115a that is associated with image 115a-b is displayed.

In one embodiment, the receiving of a first portion and the displaying of a representative image associated with that first portion continues until a target representative image is displayed. Hence, tracking chain 170 may be utilized to backtrack from a selection of a target representative image and/or any part of the process thereof, and locate one of the original selections.

Thus, embodiments of the present technology provide a method for enabling the selection and refinement of video images to find the most desirable video image. Additionally, embodiments enable the tracking of the selections received and displayed. Furthermore, embodiments of the present technology enable the reversal of selection choices utilizing the tracking chain.

### Example Computer System Environment

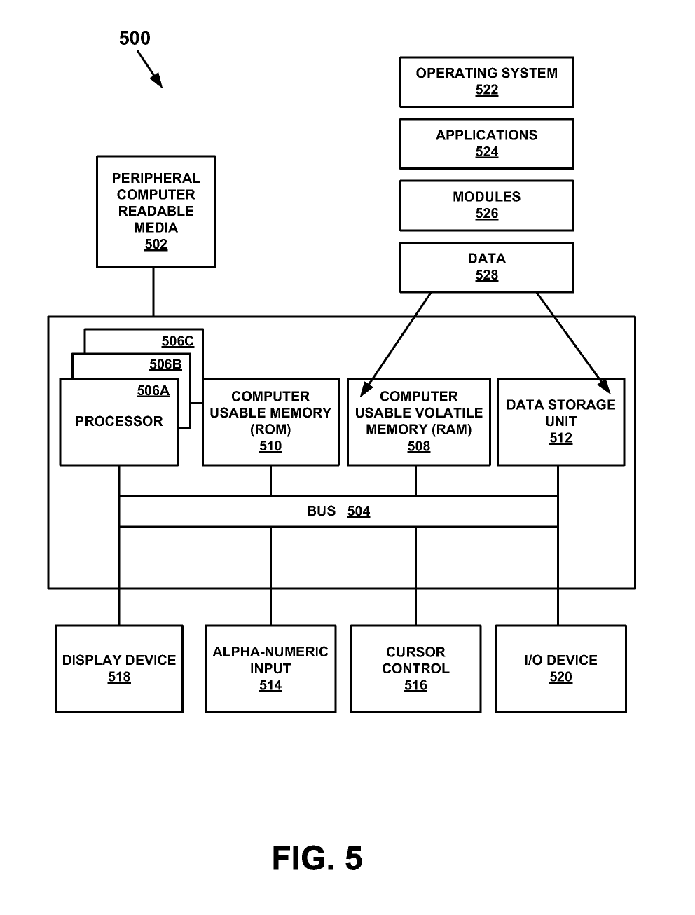

With reference now to FIG. 5, portions of embodiments of the present technology for enabling a selection of a video are composed of computer-readable and computer-executable instructions that reside, for example, in computer-usable media of a computer system. That is, FIG. 5 illustrates one example of a type of computer that can be used to implement embodiments, which are discussed below, of the present technology.

FIG. 5 illustrates an example computer system 500 used in accordance with embodiments of the present technology. It is appreciated that system 500 of FIG. 5 is an example only and that embodiments of tire present technology can operate on or within a number of different computer systems including general purpose networked computer systems, embedded computer systems, routers, switches, server devices, user devices, various intermediate devices/artifacts, stand alone computer systems, and the like. As shown in FIG. 5, computer system 500 of FIG. 5 is well adapted to having peripheral computer readable media 502 such as, for example, a compact disc, and the like coupled thereto.

System 500 of FIG. 5 includes an address/data bus 504 for communicating information, and a processor 506A coupled to bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g. random access memory (RAM), coupled to bus 504 for storing information and instructions for processors 506A, 506B, and 506C.

System 500 also includes computer usable non-volatile memory 510, e.g. read only memory (ROM), coupled to bus 504 for storing static information and instructions for processors 506A, 506B, and 506C. Also present in system 500 is a data storage unit 512 (e.g., a magnetic or optical disk and disk drive) coupled to bus 504 for storing information and instructions. System 500 also includes an optional alpha-numeric input device 514 including alphanumeric and function keys coupled to bus 504 for communicating information and command selections to processor 506A or processors 506A, 506B, and 506C. System 500 also includes an optional cursor control device 516 coupled to bus 504 for communicating user input information and command selections to processor 506A or processors 506A, 506B, and 506C. System 500 of embodiments of the present technology also includes an optional display device 518 coupled to bus 504 for displaying information.

Referring still to FIG. 5, optional display device 518 of FIG. 5 may be a liquid crystal device, cathode ray tube, plasma display device or other display device suitable for creating graphic images and alpha-numeric characters recognizable to a user. Optional cursor control device 516 allows the computer user to dynamically signal the movement of a visible symbol (cursor) on a display screen of display device 518. Many implementations of cursor control device 516 are known in the art including a trackball, mouse, touch pad, joystick or special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands.

System 500 is also well suited to having a cursor directed by other means such as, for example, voice commands. System 500 also includes an I/O device 520 for coupling system 500 with external entities.

Referring still to FIG. 5, various other components are depicted for system 500. Specifically, when present, an operating system 522, applications 524, modules 526, and data 528 are shown as typically residing in one or some combination of computer usable volatile memory 508, e.g. random access memory (RAM), and data storage unit 512, However, it is appreciated that in some embodiments, operating system 522 may be stored in other locations such as on a network or on a flash drive; and that further, operating system 522 may be accessed from a remote location via, for example, a coupling to the internet. In one embodiment, the present technology, for example, is stored as an application 524 or module 526 in memory locations within RAM 508 and memory areas within data storage unit 512.

Computing system 500 is only one example of a suitable computing environment and is not intended to suggest any limitation as to the scope of use or functionality of the present technology. Neither should the computing environment 500 be interpreted as having any dependency or requirement relating to any one or combination of components illustrated in the example computing system 500.

Embodiments of the present technology may be described in the general context of computer-executable instructions, such as program modules, being executed by a computer. Generally, program modules include routines, programs, objects, components, data structures, etc, that perform particular tasks or implement particular abstract data types. Embodiments of the present technology may also be practiced in distributed computing environments where tasks are performed by remote processing devices that are linked through a communications network. In a distributed computing environment, program modules may be located in both local and remote computer-storage media including memory-storage devices.

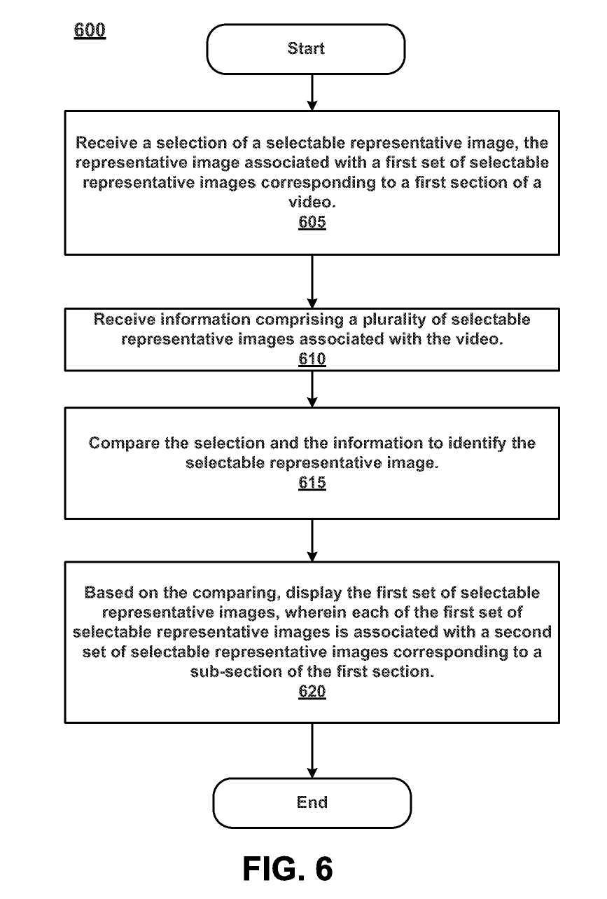

FIG. 6 is a flowchart illustrating a process 600 for enabling a selection of a video image, in accordance with one embodiment of the present technology. In one embodiment, process 600 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. In one embodiment, process 600 is performed by system 100 of FIG. 1.

Referring to 605 of FIG. 6, in one embodiment, selection of image 110b is received, wherein selection of image 110b is associated with set 115 corresponding to first section 120 of video 117.

In another embodiment and referring to 610 of FIG. 6, information comprising a plurality of selectable representative images associated with video 117 is received. Referring now to 615 of FIG. 6, selection 108 of image 110b and the information are compared to identify the selected image 110b corresponding to the selection 108. For example, the content of selection 108 is used to determine a match with the plurality of selectable representative images within the information received,

Referring to 620 of FIG. 6, in yet another embodiment, based on the comparing 615, set 115 is displayed. As described in paragraphs 24 and 25 herein, set 115 is associated with second sets of selectable representative images 135a, 135b, and 135c. Set 135a contains images 115a-a, 115a-b, and 115a-c, corresponding to sub-section 140 of first section 120.

In one embodiment of the present technology, the receiving 605, the receiving 610, the comparing 615, and the displaying 620 continue until a target representative image is displayed, thereby enabling refinable selecting of the target representative image.

Thus, embodiments of the present technology enable the selection of a video image. Such a method of selection is particularly useful to a user for quick and efficient refinement of a selection in order to locate a target representative image within a video.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method [400] of enabling a selection of a video image, said method comprising:
receiving [405] a selection of a representative image, said representative image associated with a first set of selectable representative images corresponding to a first section of a video;
in response to said receiving, displaying [410] said first set of selectable representative images, wherein each of said first set of selectable representative images is associated with a second set of selectable representative images corresponding to a sub-section of said first section: and
continuing [415] said receiving and said displaying until a target representative image is displayed, thereby enabling refutable selecting of said target representative image.

2. The method [400] of claim 1, further comprising:
displaying said representative image as part of a first group of selectable representative images.

3. The method [400] of claim 2, further comprising:
displaying said first group of selectable representative images according to an instruction, wherein said instruction designates a range of time each of said first group of selectable representative images is to represent.

4. The method [400] of claim 1, further comprising:
signaling a location within said video of said selection.

5. The method [400] of claim 3, further comprising:
highlighting said location.

6. The method [400] of claim 1, further comprising:
receiving a selection of a first portion of a displayed tracking chain, said tracking chain being configured for tracking said receiving and said displaying; and
in response to said receiving said selection of said first portion, displaying a representative image from which said first portion is derived;
continuing said receiving and said displaying until a target representative image is displayed.

7. A system [100] for enabling a selection of a video image, said system comprising:
an image selection receiver [105] configured for receiving a selection of a representative image, said representative image associated with a first set of selectable representative images corresponding to a first section of a video; and
an image displayer [130] configured for displaying said first set of selectable representative images in response to said receiving said selection, wherein each of said first set of selectable representative images is associated with a second set of selectable representative images corresponding to a sub-section of said first section,

8. The system [100] of claim 7, wherein said representative image is displayed as part of a first group of selectable representative images.

9. The system [100] of claim 7, wherein each selectable representative image of said first set of selectable representative images [115] represents a frame of time non-overlapping with a frame of time of any other selectable representative image of said first set of selectable representative images [115].

10. The system [100] of claim 9, wherein each selectable representative image of said second set of selectable representative images represents a frame or time non-overlapping with a frame of time of any other selectable representative image of said second set of selectable representative images.

11. The system of Claim 7, further comprising:
an instruction receiver [150] configured for receiving an instruction [155], wherein said instruction [155] designates a range of time of which each of said first group of selectable representative images is to represent; and
a image organizer [160] configured for configuring said first group of selectable representative images according to said instruction [155].

12. The system [100] of claim 7, further comprising:
a selection tracker [165] configured for displaying a tracking chain [170] of selected representative images, said tracking chain [170] tracking said receiving and said displaying.

13. The system [100] of claim 7, further comprising:
a location signaler [175] configured for signaling a location of a selected representative image within said video [117].

14. A computer usable medium comprising instructions that when executed cause a computer system to perform a method [600] of enabling a selection of a video image, said method [600] comprising:
receiving [605] a selection of a selectable representative image, said selectable representative image associated with a first set of selectable representative images corresponding to a first section of a video;
receiving [610] information comprising a plurality of selectable representative images associated with said video;
comparing [615] said selection and said information to identify said selectable representative image; and
based on said comparing, displaying [620] said first set of selectable representative images, wherein each of said first set of selectable representative images is associated with a second set of selectable representative images corresponding to a sub-section of said first section.

15. The method [600] of claim 14, further comprising:
continuing said receiving a selection, said receiving said information, said comparing, and said displaying until a target representative image is displayed, thereby enabling refutable selecting of said target representative image.
